(19) United States
(12) Patent Application Publication
(10) Pub. No.: US 2024/0052725 A1
(43) Pub. Date: Feb. 15, 2024

(54) CHEMICAL STICK RECEIVING PRESSURE VESSEL

(71) Applicant: FREEDOM CHEMICAL TECHNOLOGIES, LLC, Midland, TX (US)

(72) Inventors: Christopher R. FOSTER, Andrews, TX (US); Charles H. DIETZ, Odessa, TX (US); Alan L. CARDONA, Odessa, TX (US); Tommy L. ROLAND, Odessa, TX (US)

(73) Assignee: FREEDOM CHEMICAL TECHNOLOGIES, LLC, Midland, TX (US)

(21) Appl. No.: 18/266,568

(22) PCT Filed: Dec. 10, 2021
(86) PCT No.: PCT/US2021/062848

§ 371 Date: Jun. 9, 2023

Related U.S. Application Data
(60) Provisional application No. 63/124,463, filed on Dec. 11, 2020.

(51) Int. Cl. E21B 37/06; F17C 1/00

(52) U.S. Cl. CPC E21B 37/06; F17C 1/007

(57) ABSTRACT

Chemical stick receiving pressure vessel includes a housing having a body portion. Body portion forming a first opening at a first end and forming a second opening at a second end. Cap operable to close the first opening, wherein the cap forms an outlet. Plurality of stick receiving tubes mounted inside the body portion, wherein the stick receiving tubes are operable to receive chemical treatment sticks; a base portion being coupled to the second opening, wherein the base portion is operable to be placed on the ground and within a predefined proximity to a wellhead. Inlet formed on the side surface of the base portion. Fluid enters the inlet from the well-head and passes through the plurality of stick receiving tubes before exiting through the outlet to be placed in the annulus between the casing and tubing of the wellbore.

### CROSS REFERENCE TO RELATED APPLICATIONS

The present application claims the benefit of U.S. Provisional Patent Application No. 63/124,463 filed Dec. 11, 2020, the contents of which are expressly incorporated by reference herein.

### FIELD

The present disclosure relates generally to a pressure vessel for housing chemical sticks to provide for fluid treatment within a wellbore, and a method of treating fluid in the annulus of a wellbore.

### BACKGROUND

Chemical injection from the surface for downhole remediation has historically been performed by transferring the fluid media from a holding tank (bulk, truck treating) to an entry point at the surface. The chemical remediation agents would then transit down the space between the casing and tubing (“backside”). This required an external energy source for this transfer of fluids. For example, the external energy source typically includes on or more of a chemical injection pump, and/or truck treating pump. Once the fluids reached the area where artificial lift was pumping fluid up, the chemical agents would complete the circuit from surface entry to surface exit to a transfer line or battery vessel.

The creation of a downhole tool provided a means to treat fluids from the “bottom up”. All connate fluids entering the artificial lift area were exposed to chemical agents that would promote flow assurance. Consequently, the treatment and remediation began from the source reservoir near the entry point of the tubing column downhole and continued up the tubing and staying in solution in transit to the tank battery.

### BRIEF DESCRIPTION OF THE DRAWINGS

The novel features of the disclosure are set forth with particularity in the appended claims. A better understanding of the features and advantages of the present inventive concept will be obtained by reference to the following detailed description that sets forth illustrative examples, in which the principles of the disclosure are utilized, and the accompanying drawings of which:

FIG. 1 illustrates an isometric view of a chemical stick receiving pressure vessel in open configuration, according to at least one instance of the present disclosure;

FIG. 2 illustrates a top plan view of a chemical stick receiving pressure vessel, according to at least one instance of the present disclosure;

FIG. 3 illustrates a side elevational view of a chemical stick receiving pressure vessel, according to at least one instance of the present disclosure;

FIG. 4 illustrates an isometric cross-sectional view of a well protector vessel assembly taken along line 4-4 of FIG. 3, according to at least one instance of the present disclosure; and

FIG. 5 illustrates a schematic view of the chemical stick receiving pressure vessel connected to a wellhead, according to at least one instance of the present disclosure.

### DETAILED DESCRIPTION

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but can include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term substantially, as used herein, is defined to be essentially conforming to the particular dimension, shape or other word that substantially modifies, such that the component need not be exact. For example, substantially cylindrical means that the object resembles a cylinder, but can have one or more deviations from a true cylinder.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure addresses the treatment of fluids in the annulus space between the tubing and casing above the downhole pump. This necessitated a mechanism that could provide treatment for these fluids, utilizing microencapsulated chemical remediation agent that could release and treat the fluids. The challenge was to address this need without requiring aforementioned bulk tanks or treating trucks creating a footprint and possible surface environmental release of toxic agents.

The present disclosure describes a chemical stick receiving pressure vessel that addresses the need of treating the fluids. In at least one example, the treatment of fluids is in the annulus space between a casing and a tubing above the fluid entry point in the artificial lift scenario. The chemical stick receiving pressure vessel contains holding cavities that retain the solid, microencapsulated media. The operating premise is to release remediation agents into the fluids that are present at the surface as a result of the pumping action of the downhole pump. A small quantity of the fluids exiting the wellhead are diverted to the chemical stick receiving pressure vessel and circulated in the area surrounding the chemical sticks, while under pressure. The exposed, treated fluids then exit the chemical stick receiving pressure vessel and are introduced into the annular space between the casing and tubing at the well head. These treated fluids then make the transit down to the pumping zone utilizing artificial lift. Therefore, all fluids in the well bore are treated with chemical remediation agents.

The chemical stick receiving pressure vessel is readily accessible at the surface near the well-head. This allows for routine maintenance and visual inspection. The vessel chamber can be opened, inspected, and monitored for performance and reduction of the chemical stick inventory. Any loss of material due to extended release in the fluid media can be refilled. This promotes continuous chemical treatment without the need for: surface bulk tanks, treating truck deliveries, excessive traffic on company lease roads, and/or environmental release of chemical agents.

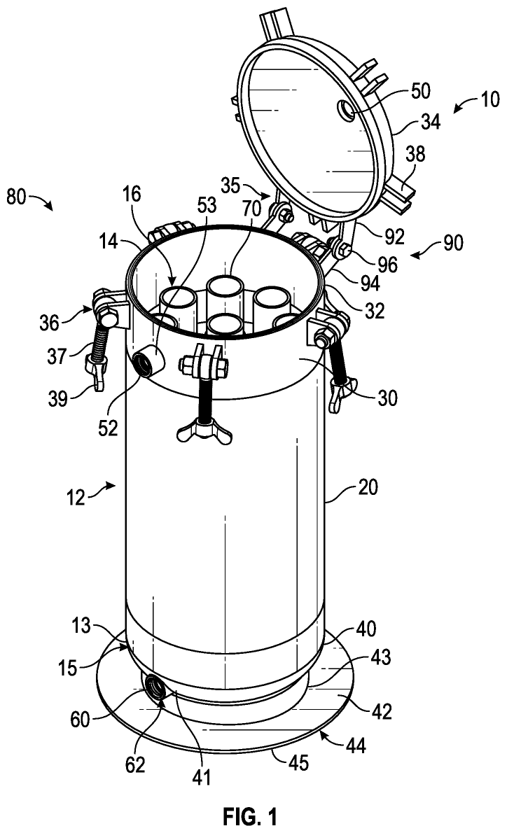

FIG. 1 illustrates an isometric view of a chemical stick receiving pressure vessel 10 in open configuration 80, according to at least one instance of the present disclosure. A chemical stick receiving pressure vessel 10 can include a housing 12 having a body portion 20. The body portion 12 can form a first opening 16 at a first end 14. The body portion 12 can form a second opening 15 at a second end 13.

The chemical stick receiving pressure vessel 10 can include a cap 34 operable to close the first opening 16. In at least one example, the cap 34 can be hingedly coupled to the housing 12. In some examples, the cap 34 can be generally removably coupled for example by a threaded connection, and/or any other suitable mechanism to couple to the housing 12. The housing 10 can form outlet 52. The outlet 52 can be configured for providing a fluid line from the chemical stick receiving pressure vessel 10 to the wellhead. The cap 34 can form another outlet 50. The another outlet 50 can be configured for receiving a pressure relief valve and/or a pressure gauge. In other examples, the another outlet 50 can be configured to provide for an additional flow line to the wellhead. A first threaded socket 51 (shown in FIG. 3) can be coupled to the cap 34 over the another outlet 50. A second threaded socket 53 can be coupled to the housing 10 over the outlet 52. In another example, the second threaded socket 53 can be coupled to the body 20 over the outlet 52 that is formed in the body 20. In the illustrated example, the second threaded socket 53 can be coupled to coupler portion 32 over the outlet 52 that is formed in the coupler portion 32.

In at least one instance, the chemical stick receiving pressure vessel 10 can include a cap portion 30. In the instances that include the cap portion 30, the first opening 16 can be described in relation to the cap portion 30 rather than body portion 12, as the cap portion 30 is affixed to the body portion 12.

The chemical stick receiving pressure vessel 10 can include a plurality of stick receiving tubes 70 disposed inside the body portion 12. In some examples, the stick receiving tubes 70 can be mounted inside the body portion 12. The stick receiving tubes 70 can be positioned within the body portion 12 such that the stick receiving tubes 70 extend parallel to a longitudinal axis of the body portion 12. The plurality of stick receiving tubes 70 are operable to receive chemical treatment sticks (not shown). The chemical treatment sticks can be as described above. While the illustrated example includes a plurality of tubes 70 that are cylindrically shaped, the tubes can take other shapes as well. The chemical treatment sticks can be sized and shaped according to the tubes. In some examples, the chemical treatment sticks are substantially shorter than the length of the tubes to allow for the chemical treatment to be controlled. The plurality of stick receiving tubes 70 can have a solid, a microencapsulated media mounted therein.

The chemical stick receiving pressure vessel 10 can include a base portion 40 being coupled to the second opening 15. The base portion 40 is operable to be placed on the ground and within a predefined proximity to a wellhead. The chemical stick receiving pressure vessel 10 can include an outlet 60 formed on the side surface 41 of the base portion 40. Fluid enters the inlet 60 from the wellhead and passes through the plurality of stick receiving tubes 70 before exiting through the outlet 52 to be placed in the annulus between the casing and tubing of the wellbore. An inlet threaded socket 62 can be coupled to the base portion 40 over the inlet 60.

The chemical stick receiving pressure vessel 10 can include a platform portion 42 that is coupled to the base portion 40 on a first side 41. The platform portion 42 can be substantially flat 45 on the other side 44, whereby the substantially flat side 45 can be positioned on the ground or other structure near the wellhead.

In the illustrated example, a plurality of fasteners 36 are operable to removably couple the cap 34 to the housing 10, whereby the cap 34 can be pivoted to expose the first opening 16 and chemical treatment sticks installed into the plurality of stick receiving tubes 70. When the plurality of fasteners 36 couple the cap 34 to the housing 10 in a closed configuration, the cap 34 forms a seal against the body portion 12 and/or the cap portion 30 such that fluid cannot pass between the cap 34 and the body portion 12 and/or the cap portion 30. The plurality of fasteners 36 each comprise a rotatable member 35 coupled to the housing 12 and a corresponding pair of ears 38 coupled to the cap 34, wherein the rotatable member 35 includes a thread portion 37 and a nut 39, whereby the nut 39 is operable to be positioned above the ears 38 and tightened onto the ears 38 and forming a fluidically sealed vessel.

In at least one example, the cap 34 can be coupled to hinge 90. The hinge 90 allows for the cap to be pivotable with respect to the housing 12. As illustrated, the hinge can include a cap hinge portion 92 and a housing hinge portion 94. The cap hinge portion 92 can be coupled to the housing hinge portion 94 through a rotable member 96. As illustrated, the rotatable member is a screw and a nut that allows the cap to pivot relative the housing. In at least one example, the housing hinge portion 94 can be coupled to the cap portion 30.

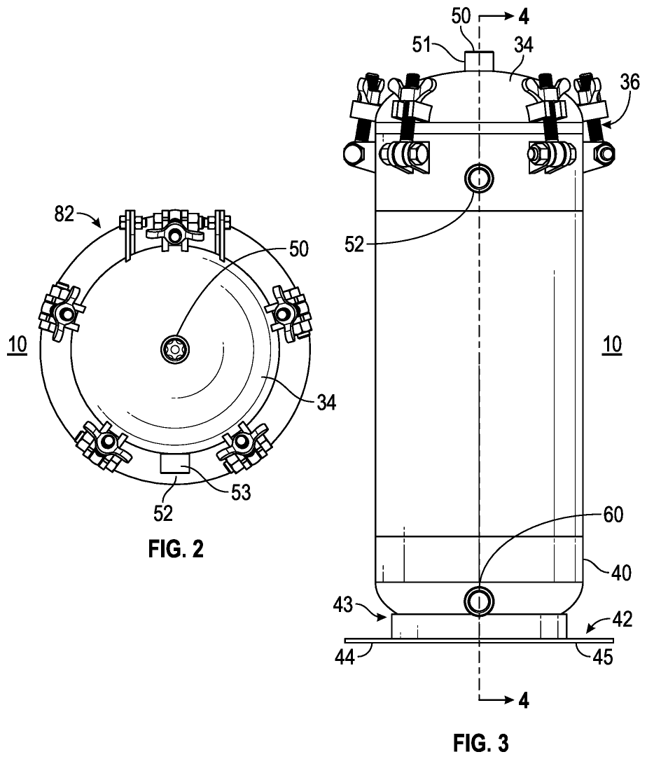

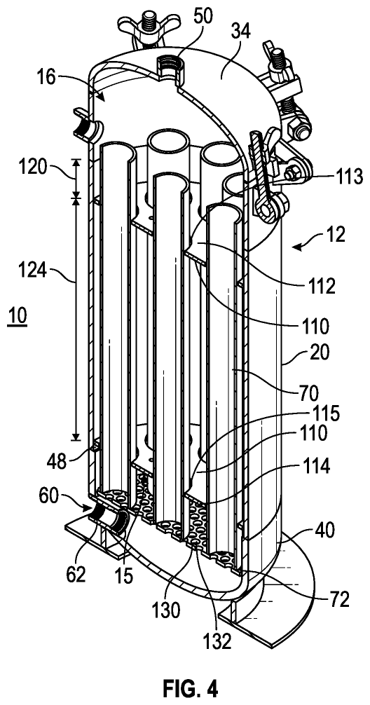

FIG. 2 illustrates a top plan view of a chemical stick receiving pressure vessel, according to at least one instance of the present disclosure. As seen in FIG. 2, the fasteners 36 are shown in the closed position 82, whereby the cap 34 is held in place by the fasteners 36. Additionally, as illustrated, the another outlet 50 is unobstructed and there is one of the plurality of stick receiving tubes located therebelow allowing the perforated member to be seen. The perforated member and the configuration with respect to the plurality of stick receiving tubes is better illustrated in FIG. 4, as described below. Additionally, the outlet 52 can be seen along with the second threaded socket 53.

FIG. 3 illustrates a side elevational view of a chemical stick receiving pressure vessel 10, according to at least one instance of the present disclosure. As illustrated the another outlet 50 is located in the cap 34. The first threaded socket 51 extends up from the cap 34. In at least one example, the first threaded socket 51 can extend through the cap 34. The fasteners 36 hold the cap 34 in place and provides that the chemical stick receiving pressure vessel 10 can be fluidically sealed with the exception of the another outlet 50, outlet 52, and inlet 60.

Additionally, FIG. 3 illustrated the base 40 and platform portion 42 in a side elevation view. As illustrated the first side 43 of the platform portion 42 can be coupled to the base portion 40. The other side 43 of the platform portion 42 can be configured to either be placed on the ground or mounted to some other skid or structure near the wellhead. In the instance that the platform portion 42 is configured to be placed on the ground the other side 43 can be a substantially flat side 45.

FIG. 4 illustrates an isometric cross-sectional view of a chemical stick receiving pressure vessel 10 taken along line 4-4 of FIG. 3, according to at least one instance of the present disclosure. The chemical stick receiving pressure vessel 10 can include at least one tube mounting member 110 that couples the plurality of stick receiving tubes 70 to the housing 12. In at least the illustrated example, the mounting member 110 can receive and couple the plurality of stick receiving tubes 70 to the body portion 20. Additionally, in the illustrated example, the at least one tube mounting member 110 includes two tube mounting members 112, 114. When there are at least two tube mounting members 112, 114, the plurality of stick receiving tubes 70 can be better stabilized in one place. The at least two tube mounting members 112, 114 are configured such that corresponding holes 113, 115 are formed therethrough. As illustrated the first tube mounting member 112 has first mounting member holes 113 formed therethrough allowing the plurality of stick receiving tubes 70 to pass therethrough. In at least one example, the plurality of stick receiving tubes 70 are removable from the first tube mounting member 112. In another example, the plurality of stick receiving tubes 70 are affixed to the first tube mounting member 112. Additionally, the second tube mounting member 114 has second mounting member holes 115 formed therethrough. The plurality of stick receiving tubes 70 can be coupled to the first tube mounting member 112 and second tube mounting member 114.

A first one 112 of the two mounting members 110 is located near the first opening 16 and a second one 114 of the two mounting members 110 is located near the second opening 15, whereby near indicates that the spacing or distance 124 between the first one 112 and the second one 116 of the two mounting members 110 is greater than the distance 120 between the first one of the two mounting members 110 and the first opening 16. In the illustrated example, the second one 116 of the two mounting members 110 is located adjacent the second end 13 of the body portion 20. In at least one example, the second one 114 of the two mounting members 110 rests on an inner portion 48 of the base portion 40.

The chemical stick receiving pressure vessel 10 can include a perforated member 130 having a plurality of holes 132 therethrough being coupled to the base portion 40 and being positioned adjacent an end 72 of the plurality of stick receiving tubes 70, whereby the perforated member 130 holds the chemical sticks within the plurality of stick receiving tubes 70. The outlet 60 can be formed on the base portion 40 below the perforated member 130.

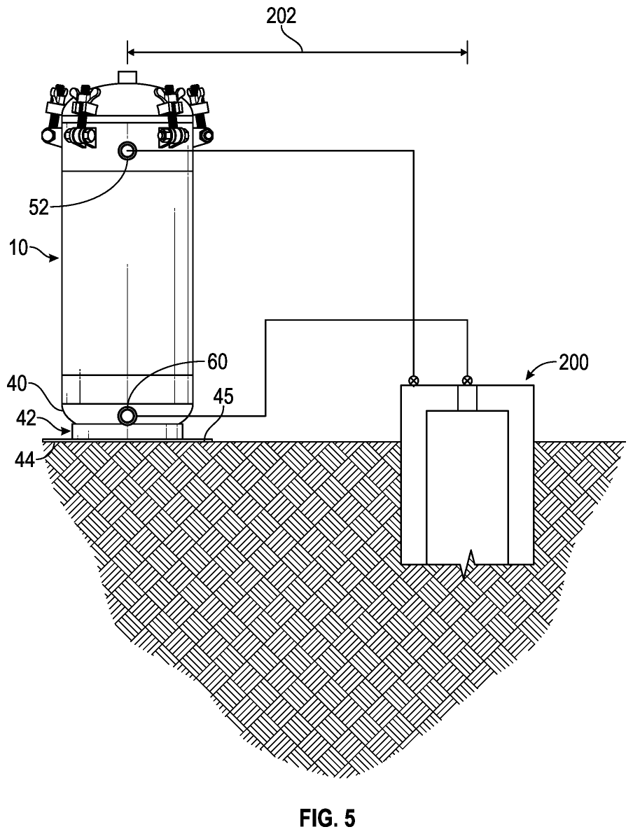

FIG. 5 illustrates a schematic view of the chemical stick receiving pressure vessel 10 connected to a wellhead 200, according to at least one instance of the present disclosure. The base portion 40 is operable to be placed on the ground and within a predefined proximity to a wellhead 200. In at least one example, the predefined proximity to the wellhead 200 can be defined as being within a radius 200 from the wellhead 200. In at least one example, the predefined proximity to the wellhead 200 is less than 40 meters. In another example, the predefined proximity to the wellhead 200 is less than 20 meters. In another example, the predefined proximity to the wellhead 200 is less than 5 meters. Fluid enters the inlet 60 from the wellhead and passes through the plurality of stick receiving tubes and around the chemical sticks before exiting through the outlet 52 to be placed in the annulus between the casing and tubing of the wellbore. The chemical stick receiving pressure vessel 10 can include a platform portion 42 that is coupled to the base portion 40 on a first side 41. The platform portion 42 can be substantially flat 45 on the other side 44, whereby the substantially flat side 45 can be positioned on the ground or other structure near the wellhead 200. The chemical sticks can be configured to have the desired release profile based upon fluid exposure within the chemical stick receiving vessel to achieve chemical remediation via the anulus.

While preferred examples of the present inventive concept have been shown and described herein, it will be obvious to those skilled in the art that such examples are provided by way of example only. Numerous variations, changes, and substitutions will now occur to those skilled in the art without departing from the disclosure. It should be understood that various alternatives to the examples of the disclosure described herein can be employed in practicing the disclosure. It is intended that the following claims define the scope of the disclosure and that methods and structures within the scope of these claims and their equivalents be covered thereby.

What is claimed is:

1. A chemical stick receiving pressure vessel comprising:
a housing having a body portion;
the body portion forming a first opening at a first end and forming a second opening at a second end;
a cap operable to close the first opening, wherein the cap forms an outlet;
a plurality of stick receiving tubes mounted inside the body portion, wherein the stick receiving tubes are operable to receive chemical treatment sticks;
a base portion being coupled to the second opening, wherein the base portion is operable to be placed on the ground and within a predefined proximity to a wellhead;
an inlet formed on the side surface of the base portion;
wherein a fluid enters the inlet from the wellhead and passes through the plurality of stick receiving tubes before exiting through the outlet to be placed in the annulus between the casing and tubing of the wellbore.

2. The chemical stick receiving pressure vessel of claim 1, wherein the plurality of stick receiving tubes have a solid, a microencapsulated media mounted therein.

3. The chemical stick receiving pressure vessel of claim 1, wherein the housing forms another outlet.

4. The chemical stick receiving pressure vessel of claim 3, further comprising a first threaded socket being coupled to the cap over the another outlet, and a second threaded socket being coupled to the housing over the outlet.

5. The chemical stick receiving pressure vessel of claim 4, further comprising an inlet threaded socket being coupled to the base portion over the inlet.

6. The chemical stick receiving pressure vessel of claim 1, further comprising a plurality of fasteners operable to removably couple the cap to the housing, whereby the cap can be pivoted to expose the first opening and chemical treatment sticks installed into the plurality of stick receiving tubes.

7. The chemical stick receiving pressure vessel of claim 6, wherein the plurality of fasteners each comprise a rotatable member coupled to the housing and a corresponding pair of ears coupled to the cap, wherein the rotatable member includes a thread portion and a nut, whereby the nut is operable to be positioned above the ears and tightened onto the ears and forming a fluidically sealed vessel.

8. The chemical stick receiving pressure vessel of claim 1, further comprising a platform portion that is coupled to the base portion on a first side and is substantially flat on the other side, whereby the substantially flat side can be positioned on the ground or other structure near the wellhead.

9. The chemical stick receiving pressure vessel of claim 1, further comprising at least one tube mounting member that couples the plurality of stick receiving tubes to the body portion.

10. The chemical stick receiving pressure vessel of claim 9, wherein the at least one tube mounting member includes two tube mounting members.

11. The chemical stick receiving pressure vessel of claim 10, wherein a first one of the two mounting members is located near the first opening and a second one of the two mounting members is located near the second opening, whereby near indicates that the spacing between the first one and the second one of the two mounting members is greater than the distance between the first one of the two mounting members and the first opening.

12. The chemical stick receiving pressure vessel of claim 11, wherein the second one of the two mounting members is located adjacent the second end of the body.

13. The chemical stick receiving pressure vessel of claim 12, wherein the second one of the two mounting members rests on an inner portion of the base portion.

14. The chemical stick receiving pressure vessel of claim 1, further comprising a perforated member having a plurality of holes therethrough being coupled to the base portion and being positioned adjacent an end of the plurality of stick receiving tubes, whereby the perforated member holds the chemical sticks within the plurality of stick receiving tubes.

15. The chemical stick receiving pressure vessel of claim 14, wherein the inlet is formed on the base portion below the perforated member.
